(19) United States
(12) Patent Application Publication
(10) Pub. No.: US 2026/0265522 A1
(43) Pub. Date: Sep. 10, 2026

(54) SILICONE IMPRESSION MATERIAL WITH ACCELERATED CURING

(71) Applicant: KULZER GMBH, Hanau (DE)

(72) Inventors: Andreas Grundler, Münzenberg (DE); Michael Hendrich, Bad Homburg (DE); Peter Deutzmann, Rommerskirchen (DE); Roman Hamburg, Niddatal-lbenstadt (DE); Peter KUNZE, Nümbrecht (DE)

(73) Assignee: KULZER GMBH, Hanau (DE)

(21) Appl. No.: 19/164,445

(22) PCT Filed: Mar. 11, 2024
(86) PCT No.: PCT/EP2024/056374

§ 371 Date: Sep. 11, 2025

(30) Foreign Application Priority Data
Mar. 13, 2023 (DE) 10 2023 106 165.8

(51) Int. Cl. C08L 83/04; C08G 77/08; C08G 77/12; C08G 77/20; C08K 3/013; C08K 3/36; C08K 5/00

(52) U.S. Cl. CPC C08L 83/04; C08G 77/08; C08G 77/12; C08G 77/20; C08K 3/013; C08K 3/36; C08K 5/0041; C08L 2312/08

(57) ABSTRACT

Curable and/or cross-linkable composition are disclosed and comprise addition-cross-linkable terminal ethylene-group-containing polydialkyl siloxanes and Si—H-group-containing polydialkyl siloxanes having a specific Si—H group content in relation to ethylene groups.

The invention relates to a curable composition comprising addition-crosslinkable polydialkylsiloxanes comprising at least two terminal ethylene groups with a specific content of Si—H groups and optionally with a specific content of Si—H groups in molar ratio to the compound of formula I.

Dental impression materials are commonly used to reproduce the spatial position of the teeth and jaw. Depending on the type of impression, the impression material placed in an impression tray remains in the patient's mouth for varying lengths of time. Many patients find this step very unpleasant, as it can impair breathing, among other things. This can lead to gagging or anxiety and, in some cases, to the impression being abandoned. The aim is to accelerate the hardening of an impression material and thus shorten the time it remains in the patient's mouth. At the same time, a processing time must be maintained in order to be able to mix and apply the impression materials. Furthermore, a high level of detail must be achieved in the impression. To achieve this, these impression materials must flow as well as possible around the tooth and surrounding tissue, even in the moist environment of the mouth.

WO 2013/025494 A1 discloses addition-crosslinkable silicone impression materials consisting of hydride-functional and vinyl-terminated siloxanes which cross-link under Pt catalysis. The impression materials heat up due to the addition of low-molecular-weight allyl silanes during the cross-linking process. These allyl silanes are also already added in U.S. Pat. No. 7,700,712 B2. This heating is caused by a reaction of the allyl silanes with the hydride-functional siloxanes contained in addition-crosslinkable silicones. WO 2013/025494 A1 states that this heating results in a shortened setting reaction.

However, due to their low molecular weight, the added allyl silanes are associated with two inherent disadvantages. The reaction of allyl silanes with hydride-functional siloxanes is very efficient, which, according to WO 2013/025494 A1, can result in a temperature increase of up to 20° C. In our opinion, this is more likely to be perceived as unpleasant or threatening by patients and may trigger pain, anxiety, or defensive reactions. Furthermore, the allyl silanes used are monofunctional and therefore cannot contribute to the formation of a silicone network, i.e., effective curing or cross-linking.

The aim of the invention was to provide curable compositions of addition-crosslinking polysiloxanes that set faster within a defined time window and are still easy to work with before this time window. In particular, the compositions should not cause any unpleasant temperature increases despite their fast setting. A temperature increase of 10° C. or more is considered unpleasant. In addition, the impression materials should continue to exhibit high detail accuracy and flow well in the moist oral environment around the tooth and surrounding tissue.

The tasks were solved by an addition-crosslinking composition according to claim 1, preferred embodiments are disclosed in the subclaims and in more detail in the description. The invention also relates to a kit according to claim 17 comprising a 2K dispensing device comprising at least two cartridges and the use according to claim 18.

The present invention describes impression materials which, compared to the prior art, have a shorter setting time, in particular shorter time windows for the hardening reaction, and preferably also have a low temperature increase. Furthermore, the setting time t₉₀−t₅ can be reduced by 10% or more, in particular by more than 20%, compared with a modified reference example according to WO 2013/025494 A1 (base paste A, catalyst paste B) with a vinyl content of the polysiloxanes according to the examples of the present invention, whereby an advantageous processing time of significantly more than one minute (industrial minute) can be set. The setting time according to the invention can be adjusted to less than 0.9 minutes, whereby the temperature increase of the curable composition can advantageously be adjusted to less than 7.5° C.

It has been found that for efficient network formation, i.e., fast curing reaction (t₉₀−t₅) as the difference between setting time (t₉₀) and processing window (t₅), a content of polysiloxanes containing specific Si—H groups must be present in the composition. A particularly efficient setting time (t₉₀−t₅) after reaching the processing time (t₅) can be set within a time of less than 0.85 minutes (industrial minutes) with a simultaneously sufficiently long processing time of greater than or equal to 1.25 minutes (industrial minutes) up to optionally less than 1.80 minutes (industrial minutes) and a temperature increase of less than or equal to 10° C., in particular less than or equal to 8° C. It may be particularly preferred if, in addition, a defined molar ratio of a monounsaturated compound to the Si—H groups is set, in particular a molar ratio of greater than five, in particular greater than six, preferably greater than 6.5, more preferably greater than or equal to 6.9, of Si—H groups to C═C groups, in particular vinyl groups, of a monounsaturated compound, i.e. mol Si—H groups/mol C═C groups of a monounsaturated compound. Preferably, the molar ratio is greater than 5 to less than or equal to 15, in particular greater than or equal to 6, particularly preferred greater than or equal to 6.5, further preferred greater than or equal to 7 to less than or equal to 15.

Curable composition according to the invention comprising addition-crosslinkable organofunctional polysiloxanes comprising i. addition-crosslinkable polysiloxanes comprising at least two terminal ethylene groups and ii. polysiloxanes comprising at least two Si—H groups, wherein the polysiloxanes containing Si—H groups have a content of Si—H groups of 4.1 mmol/g to 15 mmol/g, and optionally comprising a hydrosilylation catalyst, wherein they contain 3 to 25 wt.-% of polysiloxanes containing Si—H groups with a content of Si—H groups of 4.1 to 15 mmol/g, based on the total composition of 100 wt.-% of the curable composition.

It is particularly preferred to adjust the content of hydride-functional polysiloxanes in relation to the ethylene-groups containing polysiloxanes. Particularly preferred, in that the polysiloxanes comprising at least two Si—H groups have a Si—H group content of 4.1 mmol/g to 15 mmol/g in a molar ratio of Si—H groups of the polysiloxanes to ethylene groups of the polysiloxanes of 4:1 to 10:1, preferably from 5:1 to 10:1, particularly preferred from 6:1 to 10:1, wherein in particular the curable composition does not contain any monounsaturated compound of formula I or the content of the monounsaturated compound of formula I in the curable composition is from 0.001 to 0.5 wt.-%, in particular 0.1 to 0.5 wt.-%, wherein the total content of the composition is 100 wt.-%.

It is also preferred to adjust the content of hydride-functional polysiloxanes by using at least two specific polysiloxane compositions with different contents of polysiloxanes containing at least two Si—H groups to adjust the network formation, wherein a polysiloxane composition having a content of Si—H groups of a polysiloxane composition (a first polysiloxane composition, PS1 synonymous with polysiloxane composition PS.b) a lower content of Si—H groups, in particular less than or equal to 4.0 mmol/g, preferably from 1 to 3.5 mmol/g, and a polysiloxane composition with a Si—H group content of 4.1 to 15 mmol/g (a second polysiloxane composition, PS2 synonymous with polysiloxane composition PS.a). The polysiloxane composition with 4.1 mmol/g or more of Si—H groups is preferably present in a weight ratio of greater than 2, in particular greater than or equal to 5, in relation to the polysiloxane composition with 4.0 mmol/g or less of Si—H groups. It is further preferred that the curable composition does not contain any monounsaturated compound of formula I or that the content of the monounsaturated compound of formula I in the curable composition is from 0.001 to 0.5 wt.-%, in particular 0.1 to 0.5 wt.-%, in particular 0.1 to 0.03 wt.-%, wherein the total content of the composition being 100 wt.-%.

Furthermore, it has proven advantageous if monounsaturated compounds are contained in the composition, such as low molecular weight species, for example comprising monounsaturated compounds with H₂C═CH—CH₂—, H₂C═C(CH₃)—CH₂-groups or monounsaturated compounds of formula I. It has been found that the presence of monounsaturated compounds in a molar ratio of Si—H groups to monounsaturated compounds greater than 5 accelerates crosslinking without causing an unpleasant increase in temperature.

According to a preferred embodiment, the addition-crosslinking polysiloxanes comprising at least two terminal ethylene groups comprise polydialkylsiloxanes, polydialkylsiloxane ethers or mixtures thereof, in particular with alkyl each independently having 1 to 16 carbon atoms, preferably alkyl having 1 to 4 carbon atoms, particularly preferably methyl groups.

Preferably, the composition according to a preferred embodiment comprises essentially monounsaturated compound(s), in particular from 0.01 wt.-% to 0.4 wt.-%, in particular from 0.04 to 0.4 wt.-%, with respect to the total composition of the curable composition of 100 wt.-%.

The composition may, according to a preferred embodiment, comprise essentially monounsaturated compound of formula I

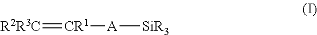

with
R each independently selected from H, monovalent alkyl group with 1 to 22 C atoms, aryl group with 16 to 12 C atoms, O—SiR⁴₃ group, wherein
R optionally comprises hetero atoms, with the provision that R is not an alkoxy group or arylalkoxy group,
R¹, R², R³ are each independently selected from H, monovalent alkyl groups with 1 to 22 C atoms, aryl groups with 6 to 12 C atoms and optionally independently comprise heteroatoms,
R⁴ is a monovalent alkyl group with 1 to 22 C atoms or an aryl group with 6 to 12 C atoms, wherein optionally two or three R⁴ radicals in O—SiR⁴₃ can form a cyclic or polycyclic structure, A is a bivalent linear, branched or cyclic hydrocarbon group with 1 to 12 C atoms, optionally comprising an aromatic compound with at least one methylene group that is directly covalently bonded to the aromatic compound, optionally comprising-O atoms, preferably A is methylene, ethylene, propylene, butylene, hexylene, octylene, nonylene or decylene,
wherein the molar ratio of Si—H groups, of the polysiloxanes containing Si—H groups, to the monounsaturated compound of formula I is greater than 5.

In particular, the molar ratio of Si—H groups, the polysiloxanes containing Si—H groups, to the C═C group of the monounsaturated compound of formula I is greater than 5.

Organofunctional silicon compounds are considered to be allylsilanes, in particular monofunctional and/or multifunctional allylsilanes. Preferred allylsilanes do not contain Si—O—Si fragments and are therefore not siloxanes. The compositions particularly preferably contain monofunctional allylsilanes and tetraallylsilane, especially in a ratio of 1:0 to 2 to 1. Preferred allylsilanes comprise R²R³C═CH₂—SiR³, R²R³C═C(CH₃) CH₂—SiR³, or R²R³C═CHCH₂—SiR³ with R² and R³ each equal to H, and/or mixtures comprising at least one of the allylsilanes with a tetraallylsilane. Alternatively, the compositions may be free of di-, tri-, or tetrafunctional allylsilanes or free of di-, tri-, and tetrafunctional allylsilanes.

It is assumed here that the processing time can be adjusted by a very specific addition of the compound of formula I in molar ratio to the Si—H groups. Thus, despite a very high Si—H content, the addition of the compound of formula I delays the onset of crosslinking and nevertheless achieves from t₅ (min.) a very rapid crosslinking (t₉₀·t₅ (min.)) with a short setting time . . .

In order to be able to adjust the processing time and the subsequent crosslinking so precisely, a specific weight ratio of the polysiloxane composition comprising Si—H groups greater than or equal to 4.1 mmol/g Si—H groups and the monounsaturated compound of formula I greater than 7 is preferred. Furthermore, it is preferred that the polysiloxane composition with greater than or equal to 4.1 mmol/g Si—H groups is preferably present in a weight ratio greater than 2, in particular greater than or equal to 5, with respect to the polysiloxane composition with less than or equal to 4.0 mmol/g Si—H groups.

On this side, curing is correlated with the cross-linking reactions. According to the invention, it is particularly important to establish a specific ratio of hydride- and vinyl-functional siloxanes and of hydride-functional siloxanes to the monounsaturated compound of formula I. Preferred monounsaturated compounds of formular I having a molecular weight of less than 500 g/mol, preferably less than 250 g/mol.

For the additive crosslinking reaction of hydride-functional polysiloxanes contained in the base component and vinyl-terminated polysiloxanes which may be contained in the base and catalyst component, these must be able to coordinate with a platinum catalyst. It has now been found that a specific ratio of at least two polysiloxane compositions, each with a defined molar content of Si—H groups in a specific ratio to polysiloxanes with at least two terminal ethylene groups, leads to accelerated curing (synonymous with curing, crosslinking or setting reaction) of the addition-crosslinkable polysiloxane-containing composition. It has also been found that increasing the reaction temperature to accelerate the addition reaction disproportionately delays the addition reaction due to the resulting competitive reaction with the monounsaturated compound of formula I and leads to unfavorable setting behavior of the composition.

The defined time window for the hardening reaction is characterized by the time difference t₉₀−t₅. Here, t₅ corresponds to the processing time, i.e., the time up to which an approximately stress-free deformation of the impression material is still possible. The time t₉₀ corresponds to the setting time. The defined time window of the hardening reaction (t₉₀−t₅) corresponds to the difference between the setting time (t₉₀) and the processing time (t₅)), i.e. the point in time at which a large part of the network has formed and only minimal deformation of the material is possible. Ideally, the time difference t₉₀−t₅ should be as short as possible so that the impression can be removed from the patient's mouth quickly. The times are determined by measuring the viscosity, in this case complex viscosity, of the mixed impression material at 30° C. using a rheometer. t₅ corresponds to the time at which 5% of the final viscosity is reached. t₉₀ corresponds to the time at which 90% of the final viscosity is reached. The complex viscosity is measured every 30 seconds as soon as the sample of the mixture of base paste and catalyst paste is no longer sticky. The measurement ends after 10 minutes. The time period defined as the time window for the curing reaction or cross-linking is defined as t₉₀minus t₅. The time period before t₅ is reached is defined as the processing window. The term “curable composition comprising addition-crosslinkable polysiloxanes” is used synonymously with “crosslinkable composition.” The processing time is followed by the setting time, which together define the time window for the curing reaction.

Furthermore, it is preferred that the time t₅ (synonymous with t₅) is at least 0.75 minutes, preferably greater than or equal to 1 minute, particularly preferably greater than or equal to 1.3 minutes, and especially preferably from 1 to 1.6 minutes, which in the present case always correspond to industrial minutes (industrial minutes, 60 minutes equal to 100 industrial minutes, i.e. =hour+min./60+sec./3600), in order to be able to produce the mixture of base component and catalyst component, apply the composition in the impression tray, insert the impression tray into the patient's mouth, and make any optional corrections. After the impression tray has been correctly placed in the patient's mouth, particularly rapid curing is desired. This rapid curing is indicated by the time difference t₉₀ minus t₅ in minutes.

The invention provides a composition that provides a time window for significantly faster additive curing, preferably less than 0.90 min, for (t₉₀−t₅) (min), particularly preferably less than 0.7 min. (t₉₀−t₅) (min.), especially less than 0.70 min.

For compositions comprising allyltrimethylsilane and optionally tetraallylsilane, curing reaction time windows (t₉₀−t₅) of 0.61 minutes (allyltrimethylsilane in base paste) and 0.83 minutes (lower Si—H content) were determined.

If polysiloxane compositions contain allyl silanes, in particular monofunctional and multifunctional allyl silanes, this results in a specifically coordinated additive curing of the hydride-functional polysiloxanes and vinyl-terminated polysiloxanes with a processing time of over one minute and subsequent very short cross-linking within less than 0.85 minutes (industrial minutes).

The invention also relates to a curable composition comprising addition-crosslinkable organofunctional polysiloxanes, in particular selected from
i. addition-crosslinkable polysiloxanes comprising at least two terminal ethylene groups, and
ii. polysiloxanes comprising at least two Si—H groups, in particular polyhydrogen-siloxanes, wherein the polysiloxanes containing Si—H groups comprise at least two polysiloxane compositions with different contents of Si—H groups, wherein a first polysiloxane composition (PS1) having a content of Si—H groups of 1 to 3.5 mmol/g and a second polysiloxane composition (PS2) having a Si—H group content of 3.8 mmol/g to 15 mmol/g, in particular the first and second and optionally further polysiloxane compositions are present as a mixture, wherein the first polysiloxane composition (PS1) with a content of Si—H groups and the second polysiloxane composition (PS2) with a content of Si—H groups are present in a weight ratio of 1:1.5 to 1:10, in particular in a weight ratio of 1:1.8 to 1:6, and optionally the molar ratio of Si—H groups of the polysiloxanes to ethylene groups of the polysiloxanes is from 4:1 to 10:1, and optionally comprising a hydrosilylation catalyst.

Preferred polysiloxanes containing at least two Si—H groups have terminal Si—H groups and optionally have pendant Si—H groups. Preferred polysiloxanes containing at least two terminal ethylene groups may optionally additionally comprise pendant ethylene groups. Polysiloxanes containing at least two terminal ethylene groups, in particular those containing at least two terminal ethylene groups, preferably comprise terminal divinyl polysiloxanes, particularly preferred divinyl polydialkylsiloxanes, alkyl with 1 to 6 C atoms, particularly preferred divinyl polydimethylsiloxanes. Polysiloxanes containing Si—H groups may also be referred to as polyhydrogensiloxanes.

Preferred hydrosilylation catalysts comprise hydrosilylation catalysts comprising platinum, rhodium and/or palladium.

A further preferred embodiment comprises a composition whose maximum temperature increase (ΔT) during curing is less than or equal to 7° C., wherein the temperature increase is measured with a temperature sensor in the mass at intervals of 15 seconds from the first mixing until 10 minutes after the first mixing, wherein in particular a temperature measurement is carried out every 30 seconds. Furthermore, it is preferred that the value t₅ in minutes from the first mixing corresponds to 5% of the complex viscosity and t₉₀ in minutes corresponds to 90% of the complex viscosity 10 minutes after the first mixing, wherein t₉₀ is less than or equal to 2.7 minutes, in particular less than or equal to 2.5 minutes, preferably less than or equal to 2.2 minutes, and/or t₅ in minutes is less than or equal to 1.8 minutes, in particular less than or equal to 1.7 minutes, preferably less than or equal to 1.6 minutes, and/or the value t₉₀−t₅ as the difference between the time t₉₀ of the complex viscosity with 90% of the complex viscosity and the time t₅ of the complex viscosity with 5% of the complex viscosity 10 minutes after initial mixing is less than or equal to 1 minute, in particular less than or equal to 0.9 minutes, and is particularly preferred to be less than or equal to 0.7 minutes. Here, “from the first mixing” is synonymous with “after” or “from the start of mixing.” Particularly preferred are the maximum temperature increase and t₉₀-t₅/min. less than 0.9 minutes, preferably less than or equal to 0.7.

The processing time t₅ in minutes (industrial minutes), i.e. the time until which an approximately stress-free deformation of the impression material is still possible, is preferably less than or equal to 1.8 minutes, preferably less than or equal to 1.6 minutes, particularly preferably less than or equal to 1.5 minutes and preferably greater than or equal to 1 minute, wherein alternatively or additionally the time window of the hardening reaction (t₉₀−t₅) in minutes is less than or equal to 0.9 minutes, preferably less than or equal to 0.85 minutes, particularly preferably less than or equal to 0.7 minutes, optionally at the same time the temperature increase being less than 7° C. It is further preferred that the processing time t₅ in minutes (industrial minutes) is greater than or equal to 0.75, in particular greater than or equal to 1.0, and less than or equal to 1.8, preferably less than or equal to 1.6.

Without being bound by theory, it is assumed that the rapid setting with good processing time is achieved by a weight ratio PS1/PS2 (PS1=crosslinking agent with Si—H (synonymous with SiH) 1.3 to 2.5 mmol/g and PS2=crosslinker with Si—H 4.1 to 8 mmol/g) of 1:1.8 to 1:6 and a molar ratio of Si—H groups to vinyl groups of 5 to 9.5, in particular 6 to 9.3.

The compositions according to the invention correspond to an easily flowable correction impression material, but in principle can be transferred to all consistencies (type 3-type 0 according to DIN EN ISO 4823:2021, DIN EN ISO 4823:2021-06).

Particularly preferred is the composition or a mixture of base component and catalyst component, especially in a ratio of 5:1 to 1:5, preferably 1:1 to 2:1 to 1:2, particularly preferred 1:1, a molar ratio of Si—H groups of the polysiloxanes to ethylene groups of the polysiloxanes of 1:1.8 to 1:6 with a first polysiloxane composition (PS1) with a content of Si—H groups of 1.3 mmol/g to 2.5 mmol/g and a second polysiloxane composition (PS2) with a Si—H group content of 4 mmol/g to 8 mmol/g, in particular of 4.1 mmol/g to 8 mmol/g, and optionally, wherein the ratio of terminal ethylene groups of the base component to terminal ethylene groups in the catalyst component is in a molar ratio of preferably 1:1.3 to 1:10, more preferably 1:1.4 to 1:2.

Furthermore, a preferred composition may comprise a content of tetraallylsilane. Preferably, a composition may comprise from 0.001 to 1.0 wt.-%, in particular from 0.001 to 0.5 wt.-%, preferably from 0.001 to 0.3 wt.-%, of tetraallylsilane with respect to the total composition of the curable composition of 100 wt.-%. In a particularly preferred alternative, the curable composition does not comprise tetraallylsilane. It has been found that a certain amount of tetraallylsilane can be added to the composition to advantageously prolong the processing time, in particular without adversely affecting the additive curing in the time window t₉₀-t₅, so that, overall, a good processing time of less than 2 minutes and subsequent rapid curing of less than 1 minute can be achieved.

The significant advantage of the invention is thus that, due to the ratio according to the invention of polysiloxanes comprising at least two terminal ethylene groups and polysiloxanes comprising at least two Si—H groups, very fast additive curing can be achieved in a time window, wherein the time window can be adjusted to longer processing times by adding tetraallylsilane and the fast curing is maintained, so that the total time from mixing to reaching 90% of Shore hardness A can be less than 3 minutes.

Furthermore, it is particularly preferred if a composition comprises at least one surfactant comprising a polyether, polyether-functionalized siloxanol oligomer, fatty alcohol and/or fluorosurfactant or mixtures of the aforementioned surfactants. Preferred surfactants may optionally comprise at least one nonionic or ionic fluorinated surfactant containing at least one fluoroalkyl group. A composition particularly preferred comprises at least one surfactant comprising a polyether and/or at least one polyether-functionalized siloxane oligomer or mixtures of the aforementioned surfactants. Preferred surfactants comprise polyether-functional siloxane surfactants and optionally a polyether, such as allyloxypolyethylene glycol alkyl ether, preferably allyloxypolyethylene glycol methyl ether, for adjusting the hydrophilicity of the composition. Preferred surfactants comprise polyether-functionalized siloxanol oligomers with at least one alkylsiloxane group and optionally a polyether. The further surfactant particularly preferably comprises at least one polyether alkylene-functionalized siloxanol oligomer with at least one alkylsiloxane group. By definition, surfactants do not contain Si—H and/or ethylene groups.

Surfactants are usually added to addition-curing impression materials in particular in order to achieve increased hydrophilicity and thus facilitate flow onto moist surfaces. In addition to classic nonionic surfactants, partially fluorinated and/or perfluorinated surfactants, sometimes in combination with classic surfactants, are also used in dental impression materials.

The content of surfactant(s) in the composition can be from 0.1 to 10 wt.-%, preferably from 0.1 to 7.5 wt.-%, particularly preferably from 0.1 to 5 wt.-%, and more preferably from 1 to 3 wt.-%, the total composition of the curable composition being 100 wt.-%.

The invention also relates to a composition comprising addition-crosslinking polysiloxanes containing at least two terminal ethylene groups with an ethylene group content of 0.01 mmol/g to 10 mmol/g, in particular vinyl groups. In particular, the polysiloxane comprising at least two terminal-ethylene groups comprising a mixture of terminal-ethylene groups comprising polysiloxanes EP1 of 0.01 to 0.07 mmol/g vinyl groups and terminal-ethylene groups comprising polysiloxanes EP2 of 0.1 to 0.5 mmol/g vinyl groups. Preferably, the polysiloxanes EP1 comprising terminal ethylene groups comprise polysiloxanes with a vinyl group content of 0.01 to 0.07 mmol/g and a viscosity of 100 mPa . . . s to 20,000 mPa . . . s (method of determination of viscosity: DIN 53015 Höppler, vinyl group content by FTIR spectroscopy using a calibration curve) and the polysiloxanes EP2 comprising terminal ethylene groups with a vinyl group content of 0.1 to 0.5 mmol/g have a viscosity of 1000 to 20000 mPa·s. The weight ratio of EP1 to EP2 is preferably in the range of 10:1 to 1:10, preferably 5:1 to 1:2. It is further preferred that in the base component the weight ratio of EP1:EP2 is from 5:1 to 2:1 and/or in the catalyst component the weight ratio of EP1:EP2 is from 2:1 to 1:10, preferably from 1.5: to 1:2.

According to a similarly preferred embodiment, a curable composition comprises a first polysiloxane composition (PS1) with a Si—H group content of 1 to 3.0 mmol/g, preferably a Si—H group content of 1.3 to 2.5 mmol/g, preferably a Si—H group content of 1.4 to 2.5 mmol/g, and a second polysiloxane composition (PS2) with a Si—H group content of 4.1 mmol/g to 10 mmol/g, preferably with a Si—H group content of 4.1 to 8.0 mmol/g, in particular 4.1 to 5.0 mmol/g, alternatively preferably with a Si—H group content of 4.1 to 7.0 mmol/g, in particular 4.15 to 6.0 mmol/g.

Furthermore, it is particularly preferred if, in the curable composition, the molar ratio of Si—H groups of the polysiloxanes to ethylene groups of the polysiloxanes is from 3.5:1 to 10:1, in particular from 6:1 to 10:1.

According to an alternative, it is preferred that the curable composition or a mixture of the base component and catalyst component contains, in particular in a ratio of 5:1 to 1:5, preferably 1:1 to 2:1 to 1:2, and particularly preferably 1:1, polysiloxanes containing Si—H groups or a polysiloxane composition (PS2) containing Si—H groups in an amount of 4.1 mmol/g to 8 mmol/g, and optionally wherein the ratio of terminal ethylene groups of the base component to terminal ethylene groups in the catalyst component is in a molar ratio of 1:1.1 to 1:10, preferably the molar ratio is 1:1.2 to 1:10, particularly preferred from 1:1.3 to 1:10, further preferred from 1:1.4 to 1:2.

According to an alternative, preferably in the curable composition or in a mixture of base component and catalyst component, in particular in a ratio of 5:1 to 1:5, preferably from 1:1 to 2:1 to 1:2, particularly preferably from 1:1, preferably a molar ratio of Si—H groups of the polysiloxanes to ethylene groups of the polysiloxanes of 1:1.8 to 1:6 with a first polysiloxane composition (PS1) with a content of Si—H groups of 1.3 to 2.5 mmol/g and a second polysiloxane composition (PS2) having a Si—H group content of 4.1 mmol/g to 8 mmol/g, and optionally wherein the ratio of terminal ethylene groups of the base component to terminal ethylene groups in the catalyst component is in a molar ratio of 1:1.1 to 1:10, preferably the molar ratio is 1:1.2 to 1:10, particularly preferably 1:1.3 to 1:10, and more preferably 1:1.4 to 1:2.

Furthermore, a composition is preferred in which polysiloxanes with a Si—H group content of 1 to 3.5 mmol/g and polysiloxanes with a Si—H group content of greater than 4.1 mmol/g are present in a weight ratio of 1:1 to 1:10, in particular in a weight ratio of 1:4 to 1:6. A composition comprising the first and second polysiloxane compositions as a mixture is also preferred, and wherein the first polysiloxane composition (PS1) and the second polysiloxane composition (PS2) are present in a weight ratio of 1:1 to 1:10, in particular in a weight ratio of 1:4 to 1:6. According to a particularly preferred embodiment, the first and second polysiloxane compositions are present as a mixture, wherein the first polysiloxane composition (PS1, polysiloxanes with a Si—H group content of 1 to 3.5 mmol/g) and the second polysiloxane composition (PS2, polysiloxanes with a Si—H group content of greater than 4.1 mmol/g) are present in a weight ratio of 1:1.5 to 1:2.2, in particular in a weight ratio of 1:1.5 to 1:2.

According to a further preferred embodiment, the curable composition is obtainable, is produced or is obtained by mixing two components to obtain an addition-crosslinking curable composition, wherein the two components comprise, in particular are selected from:
i) base components comprising addition-crosslinkable polysiloxanes comprising at least two terminal ethylene groups and polydialkylsiloxanes comprising at least two Si—H groups, in particular polydialkylsiloxanes comprising at least two terminal ethylene groups and polydialkylsiloxanes comprising at least two Si—H groups, and
ii) a catalyst component comprising a hydrosilylation catalyst comprising platinum, rhodium and/or palladium and optionally comprising addition-crosslinking terminal ethylene groups and optionally polysiloxanes comprising Si—H groups, in particular polydialkylsiloxanes containing terminal ethylene groups, and,
wherein the base component and/or the catalyst component can each independently comprise
   optionally inorganic fillers, organic particulate polymers, in particular a particle size of 10 nm to 75 micrometers, and
   optionally pigments comprising organic or inorganic pigments.

In each case, it is preferred that the base component and/or the catalyst component independently contain at least one nonionic or ionic, at least one polyether and/or a polyether-functionalized siloxane oligomer and optionally one or mixtures of the aforementioned surfactants.

According to an alternative embodiment, a curable composition comprises addition-crosslinkable organofunctional polysiloxanes comprising, in particular selected from
i. addition-crosslinkable polysiloxanes comprising at least two terminal ethylene groups, in particular polysiloxanes comprising from 0.01 to 10 mmol/g of terminal ethylene groups, preferably from 0.025 mmol/g to 5 mmol/g, particularly preferred from 0.025 mmol/g to 1 mmol/g, and
ii. polysiloxanes comprising at least two Si—H groups, in particular polyhydrogensiloxane, wherein the polysiloxanes containing Si—H groups comprise at least two polysiloxane compositions with different contents of Si—H groups, wherein a first polysiloxane composition (PS1) having a Si—H group content of 1 to 3.0 mmol/g and a second polysiloxane composition (PS2) having a Si—H group content of 3.9 mmol/g to 15 mmol/g, in particular, the first and second and optionally further polysiloxane compositions are present as a mixture, wherein the first polysiloxane composition (PS1) with a content of Si—H groups and the second polysiloxane composition (PS2) with a content of Si—H groups are present in a weight ratio of 1:1.8 to 1:6, and wherein the molar ratio of Si—H groups of the polysiloxanes to ethylene groups of the polysiloxanes is from 4:1 to 10:1.

Furthermore, a composition is preferred in which the polydialkylsiloxanes containing at least two terminal ethylene groups can be selected from vinyl-terminated polydialkylsiloxanes and vinyl-terminated polyether-functional polydialkylsiloxanes, and/or the polydialkylsiloxanes containing at least two Si—H groups can be selected from polydialkylsiloxanes and polyether-functional polydialkylsiloxanes, wherein these terminal Si—H groups and optionally in the polysiloxane backbone can contain —Si(CH₃)H groups.

Preferred polysiloxanes comprise polydialkylsiloxanes with alkyl groups each independently having 1 to 16 carbon atoms, in particular methyl groups.

According to a further preferred embodiment, the vinyl-terminated polydialkylsiloxanes and vinyl-terminated polyether-functional polydialkylsiloxanes can be selected from vinyl-terminated polydimethylsiloxanes and vinyl-terminated polyether-functional polydimethylsiloxanes. The polydialkylsiloxanes comprising Si—H groups can preferably be selected from polydimethylsiloxanes and polyether-functional polydimethylsiloxanes which contain terminal Si—H groups and optionally —Si(CH₃)H groups in the polysiloxane backbone.

Furthermore, the vinyl-terminated polysiloxanes preferably comprise vinyl-terminated polydialkylsiloxanes and vinyl-terminated polyether-functional polydialkylsiloxanes with a mean molecular weight (mass average, weight average) Mw in the range from 31,000 g/mol to 124,000 g/mol, preferably the number average Mn is in the range from 22,000 g/mol to 89,000 g/mol. It is also preferred that the polydialkylsiloxanes containing Si—H groups are selected from polydimethylsiloxanes and polyether-functional polydimethylsiloxanes, each independently with terminal Si—H groups and optionally in the polysiloxane backbone with —Si(CH₃)H groups, in particular with a mean molecular weight (mass average, weight average) Mw in the range from 500 g/mol to 19,000 g/mol, and preferably the number average Mn is in the range from 500 g/mol to 14,000 g/mol.

The polydialkylsiloxanes containing at least two terminal ethylene groups are preferably selected from vinyl-terminated polydialkylsiloxanes and vinyl-terminated polyether-functional polydialkylsiloxanes which have a viscosity of 100 to 100,000 mPa·s.

The polydialkylsiloxanes containing at least two Si—H groups are preferably selected from polydialkylsiloxanes and polyether-functional polydialkylsiloxanes which contain terminal Si—H groups and optionally —Si(CH₃)H groups in the polysiloxane backbone and with a Si—H content and optionally in the polysiloxane backbone —Si(CH₃)H groups of 4 to 8 mmol/g, in particular of 4.05 mmol/g to 8 mmol/g. It may also be preferred that the polydialkylsiloxanes containing Si—H groups are selected from polydialkylsiloxanes and polyether-functional polydialkylsiloxanes, each independently having terminal Si—H groups and optionally —Si(CH₃)H groups in the polysiloxane backbone, which have a viscosity of 10 to 500 mPa·s. The viscosity is determined as described above.

The polydialkylsiloxanes comprising terminal ethylen-groups are preferably vinyl-terminated polydialkylsiloxanes and vinyl-terminated polyether-functional polydialkylsiloxanes, with a vinyl group content in the range from 0.02 mmol/g to 2.0 mmol/g, preferably from 0.02 to 1.0 mmol/g.

According to an alternative embodiment, a composition is preferred which is obtainable or is obtained by mixing a
i) base component and
ii) catalyst component, wherein
i) the base component comprises
30 to 50 wt.-%, in particular 35 to 45 wt.-%, of polydialkylsiloxanes comprising at least two terminal ethylene groups,
15 to 64 wt.-%, in particular 30 to 50 wt.-%, of inorganic fillers,
5 to 30 wt.-%, in particular 7 to 25 wt.-%, polydialkylsiloxanes comprising at least two Si—H groups,
1.0 to 15 wt.-%, in particular 1 to 10 wt.-%, of at least one surfactant, in particular at least one polyether and/or at least one polyether-functionalized siloxane oligomer, in particular the polyether-functionalized siloxane oligomer having at least one alkylsiloxane group,
or mixtures of these surfactants, and
wherein the total amount of the base component is 100 wt.-%, and
ii) the catalyst component comprises
20 to 80 wt.-%, in particular 35 to 65 wt.-%, of polydialkylsiloxanes comprising at least two terminal ethylene groups,
5 to 70 wt.-%, in particular 35 to 65 wt.-%, inorganic fillers,
0.001 to 5.0 wt.-% of a hydrosilylation catalyst comprising platinum, rhodium or palladium,
0 to 15 wt.-% of at least one surfactant, in particular 1.0 to 15 wt.-% of at least one surfactant, in particular at least one polyether and/or at least one polyether-functionalized siloxane oligomer, in particular the polyether-functionalized siloxane oligomer having at least one alkylsiloxane group, or mixtures of these surfactants, and
0 to 10 wt.-% organic or inorganic pigments and/or structuring agents, wherein the total amount of catalyst components being 100 wt.-%.

According to a preferred alternative embodiment, the base components and the catalyst component are mixed in a weight ratio of 10:1 to 1:10, in particular in a ratio of 5:1 to 1:5, preferably of 2:1 to 1:2.

Furthermore, it is preferred that the composition is obtainable or is obtained by mixing i) a base component and ii) a catalyst component, wherein
i) the base component comprises 30 to 50 wt.-% of polydialkylsiloxanes comprising at least two terminal ethylene groups, and
ii) the catalyst component comprises 20 to 80 wt.-% of polydialkylsiloxanes containing at least two terminal ethylene groups, and wherein the ratio of terminal ethylene groups of the base component to terminal ethylene groups of the catalyst component is in a molar ratio of 1:1,1 to 1:10, preferably the molar ratio is 1:1.2 to 1:10, particularly preferably 1:1.3 to 1:10, and more preferably 1:1.4 to 1:2.

According to a further alternative, the invention relates to a kit comprising a 2K dispensing device comprising at least two cartridges, wherein the i) base component is present in one cartridge and the ii) catalyst components are present in the second cartridge. The kit may further comprise at least one removable and attachable static mixer.

Compounds of formula I comprise: H₂C═CH—CH₂Si(CH₃)₃ CAS: [762-72-1], H₂C═CH—(CH₂)₂Si(CH₃)₃, H₂C═CH—(CH₂)₃ Si(CH₃)₃, H₂C═CH—(CH₂)₄Si(CH₃)₃, H₂C═CH—(CH₂)₈Si(CH₃)₃, H₂C═CH—CH₂Si(i-C₃H₇)₃ CAS: [24400-84-8], H₂C═CH—(CH₂)₂Si(i-C₃H₇)₃, H₂C═CH—(CH₂)₃Si(i-C₃H₇)₃, H₂C═CH—(CH₂)₄Si(i-C₃H₇)₃, H₂C═CH—(CH₂)₂Si(CH₃)₂(t-C₄H₉), H₂C═CH—(CH₂)₃Si(CH₃)₂(t-C₄H₉), H₂C═CH—(CH₂)₄Si(CH₃)₂(t-C₄H₉), H₂C═CH—(CH₂)₈Si(CH₃)₂(t-C₄H₉), H₂C═CH—CH₂Si(C₂H₅)₃, H₂C═CH—(CH₂)₂Si(C₂H₅)₃, H₂C═CH—(CH₂)₃Si(C₂H₅)₃, H₂C═CH—(CH₂)₄Si(C₂H₅)₃, H₂C═CH—(CH₂)₈Si(C₂H₅)₃, H₂C═CH—CH₂Si(CH₃)₂(n-C₁₈H₃₇), H₂C═CH—(CH₂)₂Si(CH₃)₂(n-C₁₈H₃₇), H₂C═CH—(CH₂)₃Si(CH₃)₂(n-C₁₈H₃₇), H₂C═CH—(CH₂)₄Si(CH₃)₂(n-C₁₈H₃₇), H₂C═CH—(CH₂)₈Si(CH₃)₂(n-C₁₈H₃₇), H₂C═CH—CH₂Si(CH₃)₂(C₆H₅), H₂C═CH—(CH₂)₂Si(CH₃)₂(C₆H₅), H₂C═CH—(CH₂)₃—Si(CH₃)₂(C₆H₅), H₂C═CH—(CH₂)₄Si(CH₃)₂(C₆H₅), H₂C═CH—(CH₂)₈Si(CH₃)₂(C₆H₅), H₂C═CH—CH₂—O—Si(CH₃)₃, H₂C═CH—CH₂—O—Si(C₂H₅)₃, H₂C═CH—CH₂—O—Si(i-C₃H₇)₃, H₂C═CH—CH₂—O—Si(CH₃)₂(t-C₄H₉), H₂C═CH—CH₂—O—Si(CH₃)₂(n-C₁₈H₃₇), H₂C═CH—CH₂—O—Si(CH₃)₂(C₆H₅), H₂C═CH—CH₂Si(CH₃)₂—O—Si(CH₃)₃, H₂C═CH—(CH₂)₂Si(CH₃)₂—O—Si(CH₃)₃, H₂C═CH—(CH₂)₃Si(CH₃)₂—O—Si(CH₃)₃H₂C═CH—(CH₂)₄Si(CH₃)₂—O—Si(CH₃)₃, H₂C═CH—(CH₂)₈Si(CH₃)₂—O—Si(CH₃)₃, H₂C═CH—CH₂Si(CH₃)(—O—Si(CH₃)₃)₂, H₂C═CH—(CH₂)₂Si(CH₃)(—O—Si(CH₃)₃)₂, H₂C═CH—(CH₂)₃Si(CH₃)(—O—Si(CH₃)₃)₂, H₂C═CH—(CH₂)₄Si(CH₃)(—O—Si(CH₃)₃)₂, H₂C═CH—(CH₂)₈Si(CH₃)(—O—Si(CH₃)₃)₂, H₂C═CH—CH₂Si(—O—Si(CH₃)₃)₃, H₂C═CH—(CH₂)₂Si(—O—Si(CH₃)₃)₃, H₂C═CH—(CH₂)₃Si(—O—Si(CH₃)₃)₃, H₂C═CH—(CH₂)₄Si(—O—Si(CH₃)₃)₃, H₂C═CH—(CH₂)₈Si(—O—Si(CH₃)₃)₃, H₂C═CH—CH₂Si(OCH₃)₃, H₂C═CH—(CH₂)₂Si(OCH₃)₃, H₂C═CH—(CH₂)₃Si(OCH₃)₃, H₂C═CH—(CH₂)₄Si(OCH₃)₃, H₂C═CH—(CH₂)₈Si(OCH₃)₃, H₂C═CH—CH₂Si(OC₂H₅)₃, H₂C═CH—(CH₂)₂Si(OC₂H₅)₃, H₂C═CH—(CH₂)₃ Si(OC₂H₅)₃, H₂C═CH—(CH₂)₄Si(OC₂H₅)₃, H₂C═CH—(CH₂)₈Si(OC₂H₅)₃, H₂C═CH—CH₂Si(C₆H₅)₃ CAS: [18752-21-1], H₂C═CH—(CH₂)₂Si(C₆H₅)₃, H₂C═CH—(CH₂)₃Si(C₆H₅)₃, H₂C═CH—(CH₂)₄Si(C₆H₅)₃, H₂C═CH—(CH₂)₈Si(C₆H₅)₃, H₂C═C(CH₃)—CH₂Si(CH₃)₃ CAS: [18292-38-1], H₂C═CH—CH₂Si(p-C₆H₄₀CH₃) CAS: [68469-60-3], H₂C═CH—CH₂Si(CH₃)₂H, H₂C═CH—(CH₂)₂Si(CH₃)₂H, H₂C═CH—(CH₂)₃Si(CH₃)₂H, H₂C═CH—(CH₂)₄Si(CH₃)₂H, H₂C═CH—(CH₂)₈Si(CH₃)₂H, and mixtures thereof.

Preferably, at least one further surfactant is selected from polyether and polyether-functionalized siloxanol oligomers, wherein the siloxanol oligomer contains at least one alkylsiloxane group, in particular the polyethers and/or the polyether groups of the polyether-functionalized siloxane oligomers are selected from polyalkylene oxide groups, in particular the polyalkylene oxide groups are selected from polyethylene oxide groups comprising methoxy-polyethylene oxide-alkylene groups, ethoxy polyethylene oxide alkylene groups, methoxy ethylene oxide alkylene groups, polyethylene oxide alkylene groups.

The at least one further surfactant is further preferred to comprise or be selected from polyethers and polyether-functionalized siloxanol oligomers, wherein the siloxanol oligomer contains at least one alkyl trisiloxane group, a polyalkylene oxide-functionalized heptamethyl trisiloxane is preferred, more preferably a polyethylene oxide alkylene-functionalized heptamethyltrisiloxane, particularly preferred is 3-(2-methoxyethoxy) propyl-methyl-bis(trimethylsilyoxy)silane.

The surfactant is particularly preferred to be selected from polyethers and polyether-functionalized siloxanol oligomers, wherein the siloxanol oligomer contains at least one alkylsiloxane group, in particular the polyethers and/or the polyether groups of the polyether-functionalized siloxanol oligomers are selected from polyalkylene oxides.

The polyalkylene oxide groups of the polyether-functionalized siloxane oligomers are preferably selected from polyethylene oxide groups, methoxy-polyethylene oxide-alkylene groups, ethoxy-polyethylene oxide-alkylene groups, methoxy-ethoxy-alkylene groups, polyethylene oxide alkylene groups, a polyalkylene oxide-functionalized alkyltrisiloxane is preferred, preferably a polyalkylene oxide-functionalized heptamethyltrisiloxane, and polyalkylene oxide alkylene-functionalized heptamethyltrisiloxane is particularly preferred. The viscosity of the further surfactant is preferably between 15 and 24.1 mPas. Preferred further surfactants comprise: 3-(2-methoxyethoxy) propyl-methyl-bis(trimethylsilyoxy)silane.

Polyether comprises α- and/or ω-polyether of alkenyl polyethers, alkynyl polyethers, hydroxy polyethers, aryloxy, arylalkyloxy and/or alkoxy-terminated polyethers. Preferred polyethers comprise α-alkenylene-ω-alkyl polyethers with C1 to C8 alkenylene and C1 to C4 alkyl, preferably allyl polyethylene glycol methyl ether (CAS 27252-80-8) and/or α, ω-alkyl polyethers with C1 to 4 alkyl. The further surfactant may preferably be present as a mixture of polyethers and polyether-functionalized siloxanol oligomers.

Polyether according to the present invention may comprise C2 to C4 alkylene oxides as surfactant or polyether-functional polydialkylsiloxanes containing terminal ethylene groups.

The polyether-functional polydialkylsiloxanes containing terminal ethylene groups are preferably selected from vinyl-terminated polyether-functional polydialkylsiloxanes comprising C2 to C4 alkylene oxides. Suitable polyols for the preparation of the polyethers are, for example, the reaction products of ethylene glycol, propylene glycol, butanediol or hexanediol isomers with one or more of the following alkylene oxides: ethylene oxide, propylene oxide or butylene oxides, such as tetrahydrofuran. Furthermore, polyethers can also be reaction products of polyfunctional alcohols such as glycerin, trimethylolethane or trimethylolpropane, pentaerythritol or sugar alcohols or mixtures of two or more thereof with the aforementioned alkylene oxides, which are suitable for forming the polyether polyols.

Suitable hydrosilylation catalysts comprising of platinum, rhodium or palladium are understood to be catalysts containing platinum, rhodium or palladium or their precatalysts, which can be dissolved in the siloxanes and preferably in the components. Catalysts which do not form a disperse phase in the other compounds present in the components are therefore preferred. Preferred are platinum complexes comprising ethylenic siloxane compounds, preferably divinyl disiloxanes. Typical precatalysts are hexachloroplatinic acid dissolved in isopropanol (Speier catalyst) and Karstedt catalysts (H₂PtCl₆) and divinyldisiloxanes such as (CH₂═CH)Me₂Si—O—SiMe₂(CH═CH₂). Karstedt catalysts may contain divalent platinum(0) complexes. Similarly preferred hydrosilylation catalysts comprise [1,3-bis(cyclohexyl) imidazol-2-ylidene][1,3-divinyl-1,1,3,3-tetramethyldisiloxane]platinum(0)(ICy)Pt(vs); [1,3-bis(2,6-diisopropylphenyl)imidazol-2-ylidene][1,3-divinyl-1,1,3,3-tetramethyldisiloxane]-platinum(0), (IPr)Pt(vs).

Alternatively, the polydimethylsiloxanes may have 1 to 10 mol % of the methyl groups in the siloxane backbone substituted by alkyl groups with C2 to C16, in particular C2 to C8, and/or phenyl groups. Alternatively, allyl-terminated polydialkylsiloxanes or allyl-terminated polyether-functional polydialkylsiloxanes can also be used.

Furthermore, compositions are preferred in which the vinyl-terminated polydialkylsiloxanes and vinyl-terminated polyether-functional polydialkylsiloxanes have an average molecular weight (mass average, weight average) Mw in the range from 31,000 g/mol to 124,000 g/mol, preferably the number average Mn is in the range from 22,000 g/mol to 89,000 g/mol, and/or the polydialkylsiloxanes containing Si—H groups are preferably selected from polydimethylsiloxanes and polyether-functional polydimethylsiloxanes with terminal Si—H groups and optionally with groups containing —Si(CH₃)H— in the polysiloxane backbone, in particular with a mean molecular weight (mass average, weight average) Mw in the range from 500 g/mol to 19,000 g/mol, and preferably the number average Mn is in the range from 500 g/mol to 14,000 g/mol. Mw and Mn can be determined by gel permeation chromatography (SDB copolymer with toluene eluent).

Compositions comprising polydialkylsiloxanes containing terminal ethylene groups, which are selected from vinyl-terminated polydialkylsiloxanes and vinyl-terminated polyether-functional polydialkylsiloxanes having a viscosity of 100 to 100,000 mPas, and/or in which the polydialkylsiloxanes containing Si—H groups are selected from polydialkylsiloxanes and polyether-functional polydialkylsiloxanes which contain terminal Si—H groups and optionally in the polysiloxane backbone —Si(CH₃)H groups in the polysiloxane backbone and have a viscosity of 10 to 500 mPa·s, in particular from 20 to 50 mPa·s (DIN 53015 Höppler ball 3) and optionally from 200 to 340 mPa·s (DIN 53015 Höppler ball 4). The viscosity is generally determined using (DIN 53015 Höppler), whereby for polydialkylsiloxanes comprising ethylene groups, the viscosity can be determined using rotational viscosity cone (4°/40 mm)/plate BU-Q 30.027) U0.2/U1: DIN 53015 Höppler ball 5.

Likewise, curable compositions, base and/or catalyst components comprising polydialkylsiloxanes containing Si—H groups of a first polysiloxane composition are preferred, which comprise the terminal Si—H groups and optionally —Si(CH₃)H groups contained in the polysiloxane backbone, wherein the content of Si—H and optionally —Si(CH₃)H groups in the polysiloxane backbone being 1 to 3.5 mmol/g, preferably 1 to 2 mmol/g. Also preferred are polydialkylsiloxanes comprising Si—H groups as the base and/or catalyst component of a second polysiloxane composition, which comprise the terminal Si—H groups and optionally —Si(CH₃)H groups, wherein the content of Si—H and optionally in the polysiloxane backbone of —Si(CH₃)H groups is from 3.8 to 15 mmol/g, preferably the content is from 4 to 8, in particular 4.05 to 8 mmol/g mmol/g.

Preferred curable compositions comprise a i) base component and a
ii) catalyst component, or are optionally obtainable by mixing an
i) base component and ii) catalyst component, wherein i) comprising
30 to 50 wt.-%, in particular 20 to 39 wt.-%, of polydialkylsiloxanes comprising terminal ethylene groups,
15 to 64 wt.-%, in particular 36 to 63 wt.-%, inorganic fillers,
5 to 30 wt.-%, in particular 5 to 21 wt.-%, polydialkylsiloxanes containing Si—H groups,
1.0 to 15 wt.-%, in particular 1 to 10 wt.-%, of at least one surfactant and optionally at least one further surfactant comprising at least one polyether and/or at least one polyether-functionalized siloxane oligomer, particularly preferred from 4 to 8 wt.-%, at least one polyether and/or at least one polyether-functionalized siloxane oligomer, in particular the polyether-functionalized siloxane oligomer having at least one alkylsiloxane group, or mixtures of these surfactants, preferably the further surfactant is at least one polyether-functionalized siloxane oligomer, and 0 to 10 wt.-%, in particular 0.001 to 0.5 wt.-%, palladium-containing composition, and
0 to 10 wt.-% organic or inorganic pigments and/or structuring agents,
where the total sum of the components in the base component is 100 wt.-%, and
ii) comprising
20 to 80 wt.-%, in particular 30 to 80 wt.-%, of polydialkylsiloxanes comprising terminal ethylene groups, particularly preferably 36 to 61 wt.-%,
5 to 70 wt.-%, in particular 36 to 61 wt.-%, inorganic fillers,
0.001 to 5.0 wt.-%, in particular 0.2 to 1.0 wt.-%, of a hydrosilylation catalyst containing platinum, rhodium or palladium, in particular a hydrosilylation catalyst containing platinum, preferably a Karstedt catalyst,
1.0 to 15 wt.-%, in particular 1 to 10 wt.-%, of at least one surfactant and optionally at least one further surfactant comprising at least one polyether and/or at least one polyether-functionalized siloxane oligomer, in particular the polyether-functionalized siloxane oligomer having at least one alkylsiloxane group, or mixtures of these surfactants, preferably the further surfactant is at least one polyether-functionalized siloxane oligomer,
0 to 10 wt.-% organic or inorganic pigments and/or structuring agents, the total amount of the components in the catalyst component being 100 wt.-%,
wherein the total content of the at least one surfactant and optionally the at least one further surfactant comprises at least one polyether and/or at least one polyether-functionalized siloxanol oligomer or a mixture of the aforementioned surfactants in a composition of 2.0 to 20 wt.-%.

Structural agents such as rheology modifiers, such as aerosols or the like, can be used. Palladium-containing compositions can be added to the curable compositions as hydrogen scavengers. Silicon dioxide, pyrogenic silica, precipitated silica, quartz, and kaolin can be used as inorganic fillers or organic particulate polymers, wherein the inorganic fillers are preferably hydrophobic. Other surfactants that may be used include fatty alcohols, such as ethoxylated fatty alcohols, in particular C11 to C14 alcohols.

According to a preferred embodiment, the base component and the catalyst component can be mixed in a weight ratio of about 1:1 to 10:1, preferably about 1:1 or about 5:1 or about 4:1 or about 10:1. Particularly preferred are weight ratios of 2:1 to 1:2, further preferred 1:1 with a deviation of +/−15 wt.-%.

The invention also relates to the use of the composition for making impressions in the medical, dental, and/or veterinary fields, for making impressions in the field of botany, for making impressions in the marine and aquatic fields, for making impressions of surfaces of articles, for making impressions of designs, art or handicraft objects, as a dental impression material, as an impression material for human, veterinary or marine soft (tissue) and/or hard structures (bones, shells, coral), such as ear impressions, podiatry, forensic technology, for making impressions of electronic components, for making impressions of objects whose surfaces are wetted with aqueous compositions or whose surfaces are wetted with water, and/or for printing three-dimensional structures, particularly in the semiconductor field.

The compositions according to the invention are suitable as molding materials in which a high level of detail must be achieved. Molding material, in particular dental molding material, comprising precision impression materials, situation impression materials, bite registration materials, duplication materials (applicable for the duplication of master models, such as all-ceramic restorations, inlays, onlays, cantilevers), as well as modeling materials, such as those used for gum reconstruction.

The following are examples of embodiments intended to explain the invention without limiting it to the specific examples.

### EXAMPLES

The figures show:

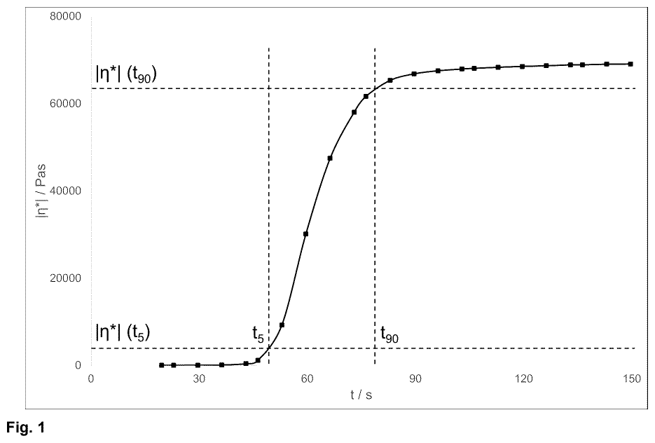

FIG. 1: Complex viscosity (η*(t5),η*(t90) over 10 minutes),
HAAKE RheoStress 1, rotational rheometer, oscillation mode, 30° C. of the modified reference sample with PS2

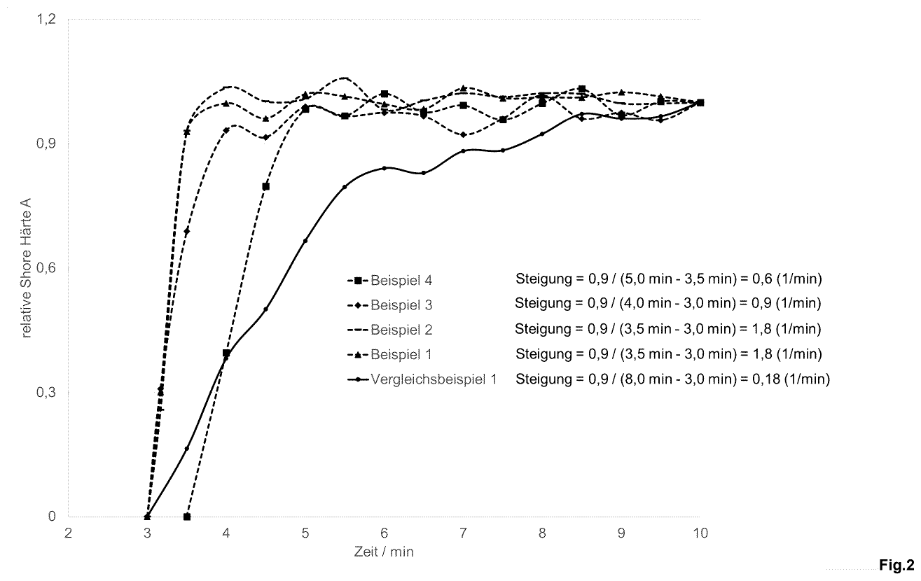

FIG. 2: Comparison of relative Shore hardness A with 6.2 to 16 wt.-% PS2 (4.17 mmol/g) shows the influence of a high SiH/vinyl ratio (molar ratio of SiH groups of the polysiloxanes to ethylene groups of the polysiloxanes at constant content of the compound of formula I, here ATMS

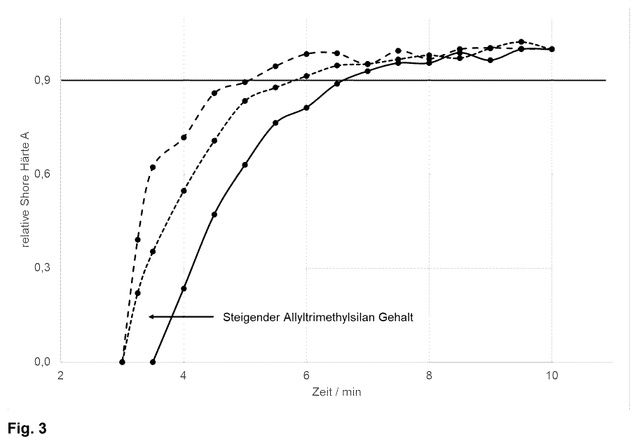

FIG. 3: Variation of the allyl silane content (ATMS) with non-inventive combinations compositions (U.S. Pat. No. 7,700,712B2, example D), wherein with ATMS contents (1.5 wt.-% ATMS, 0.4 wt.-%, 0.0 wt.-% ATMS), wherein the ATMS content was replaced by crystalline SiO₂ΔT 6.3° C. to 4.5° C.

The base pastes (base component) and catalyst paste (catalyst component) were each homogenized separately in a planetary mixer. For the subsequent tests, 60 g batches comprising the respective paste were prepared in a Hauschild beaker. The base paste and catalyst paste prepared in this way were then filled into cartridges. In the following examples, the base paste and catalyst paste were mixed in a weight ratio of 1:1 using static mixers.

### VISCOSITY MEASUREMENTS

According to FIG. 1, the complex viscosity was measured on a HAAKE™ RheoStress™ 1 rotational rheometer, oscillation mode, at 30° C. and plotted as [|η*|Pas] vs t [min]. Continuous increase in shear rate to 8 Hz, followed by a reduction in shear rate, with viscosity measured at 3 Hz. The complex viscosity after 10 min corresponds to the maximum value, t₉₀ corresponds to the time at 90% of this value, and t₅ corresponds to the time at 5% of the maximum value.

Procedure: The complex viscosity during curing is measured using a rheometer at 30° C.

### Measurement Conditions for Viscosity Measurement

| Device | RheoStress 1 | |
|---|---|---|
| Manufactur | Thermo Scientific | |
| Measuring device | Plate/plate, profiled | |
| Measurement geometry | P20 Ti L S | |
| Measuring plate | MPC20 S | |
| attachment | | |
| Type Rotary body | PP20PRO. | |
| Measuring temperature | 30° | C. |
| Measuring frequency | 1.0 | Hz |
| Shear stress | 800 | Pa |
| Split height | 0.5 | mm |
| Gap volume | 0.2 | ml |

| | |
|---|---|
| Rotation mode | CS |
| Measurement type | Oscillation |
| Measurement duration | No change in viscosity curve visible = |
| | termination, or max. 10 min |

The sample quantity was as follows: m=(1.0±0.1) g

The Shore hardness A (DIN 53505:2000-08) is measured every 30 seconds at (23±2° C.) as soon as the test specimen of the mixture of base paste and catalyst paste is no longer sticky, i.e. an initial measurement is carried out as soon as the film can be removed from the material. The last measurement point is 10 minutes after mixing the aforementioned pastes.

The final viscosity is read after 10 minutes and used to calculate the values t₅ (time at 5% of the final viscosity) and t₉₀ (time at 90% of the final viscosity). The times are obtained by extrapolating the curves at the corresponding viscosity value.

A relative Shore hardness A is calculated by normalizing to the value of Shore hardness A at t=10 min. A time t^{SH} is then calculated from the difference between the first possible measurement and the time after 90% of the Shore hardness has been reached within 10 minutes. The shorter t^{SH} is, the faster the material hardens.

The difference between t₉₀−t₅ in minutes (industrial time) indicates the transition time (defined time window for setting reaction or curing) from the plastic to the elastic state. The shorter t₉₀−t₅ is, the faster the composition cures within this time window.

TABLE 1
Shore hardness A, t^{SH} (min.), t = (t₉₀ − t₅) (min.), ΔT (° C.)

| | | | Comparison | Comparative |
|---|---|---|---|---|
| | | | example | example |
| | | | Example D | (WO2013/025494A1) |
| Shore | Exam- | Exam- | U.S. Pat. No. | Example 1 |
| hardness A | ple 1 | ple 2 | 7,700,712B2 | B/A |
| t^{SH} (min) | 00:00 | 00:00 | 4:30 | 0 |
| t⁵ (min) | 1.46 | 1.49 | 1.9 | 1.83 |
| t = (t⁹⁰ − | 0.61 | 0.61 | 2.5 | 0.94 |
| t⁵) (min) | | | | |
| ΔT (° C.) | 7.4 | 7.3 | 5.7 | 11.7 |

### Temperature Measurement

### Description of the Method:

1. A tube (21 mm diameter laminate tube=plastic-coated aluminum tube) is cut to a length of approximately 5 cm.
2. The tube is filled with material by dispensing from the cartridge using a static mixer (1:1 systems, 5:1 with dynamic mixer) so that the tube contains approximately 8 g of material. The time is started when the first dispensing from the cartridge begins. The quantities were weighed after the test.
3. The temperature sensor of the measuring device (type: Testo 925) is placed in the mass. After 15 seconds, the first measurement is recorded. 4. From 30 seconds onwards, the temperature is recorded every 30 seconds for 10 minutes. At this point, all samples had already passed their maximum temperature and the temperature was steadily decreasing.
5. The sample is removed from the temperature measuring device and weighed (m=8 g+/−0.5 g).

### Mixture of Polydimethylsiloxane (PDMS Oil)

### Comparison Example A

Polydimethylsiloxane with terminal vinyl groups

(vinyl content: 0.26 mmol/g)

Polydimethylsiloxane with terminal vinyl groups (vinyl content: 0.13 mmol/g)

Polydimethylsiloxane with terminal vinyl groups

(vinyl content: 0.05 mmol/g)

### EXAMPLES ACCORDING TO THE INVENTION AND MODIFIED REFERENCE EXAMPLES

The vinyl content in the base pastes of the following examples is: C═C group content: from 0.05 to 0.09 mmol/g (Example 1=0.09 mmol/g, Examples 2 and 3=0.07 mmol/g and Example 4:0.05 mmol/g

### Polydimethylsiloxane (PDMS Oil) Mixture:

The vinyl content in the catalyst pastes of the following examples is: C═C group content: 0.088 mmol/g

Comparative examples and modified reference example: In Example D of U.S. Pat. No. 7,700,712 B2 and in the examples of WO2013/025494, Example 1, B/A, no information on the vinyl content or C═C content is disclosed; therefore, the vinyl content was adjusted analogously to the above base and catalyst pastes.

Crosslinking agent: Poly(methyl)(hydrogen)siloxane

crystalline SiO₂: cristobalite

Palladium dispersion (Pd dispersion): Palladium chloride dispersion in divinylpoly-dimethylsiloxane

Catalyst: Platinum tetramethyldivinyldisiloxane complex, Karstedt catalyst Preparation (4 wt.-% Pt)

The mixing ratio of base paste and catalyst paste is 1:1 unless otherwise specified. The following examples according to the invention and further examples were all carried out with the same mixture of PDMS oil (polydimethylsiloxane). Therefore, the examples given as reference examples are not comparative examples according to the prior art, but internal reference examples.

TABLE 2
Comparative examples and modified reference example

| | Comparative example | | | | | | | |
|---|---|---|---|---|---|---|---|---|
| | WO 2013/025494 | | Modified reference | | Comparative | | Comparative | |
| | Example 1 (B/A) | | example with PS2 | | example 1 | | example A | |
| | 3% allyl- | | 3% allyl- | | Example D | | Example A | |
| | trimethylsilane | | trimethylsilane | | US 7700712B2 | | US 7700712B2 | |
| | in base | | in cat | | 1:1 | | 5:1 | |
| | base | Catalyst | Base | Catalyst | Base | Catalyst | Base | Catalyst |
| | [wt.-%] | [wt.-%] | [wt.-% | [wt.-%] | [wt.-%] | [wt.-%] | [wt.-%] | [wt.-%] |
| Mixture PDMS | 40.7 | 49.1 | 40 | 49.1 | 43.8 | 40.7 | 27.1 | 30 |
| Oil content | | | | | | | | |
| C═C in | | | | | | | | |
| WO | | | | | | | | |
| 2013/025494 | | | | | | | | |
| not specified* | | | | | | | | |
| Crosslinker | 5.7 | — | 6.4 | — | 6.0 | — | 7.5 | — |
| PS1 (1.8 | | | | | | | | |
| mmol/g SiH) | | | | | | | | |
| Crosslinker | 11.6 | — | — | — | 7.0 | — | — | — |
| PS** (4.0 | | | | | | | | |
| mmol/g SiH) | | | | | | | | |
| Crosslinker | — | — | 11.6 | — | — | — | — | — |
| PS2 (4.17 | | | | | | | | |
| mmol/g SiH) | | | | | | | | |
| n(vinyl) | 7.1 | | 7.0 | | 11.0 | | 5.5 | |
| mmol/wt-%] | | | | | | | | |
| n(SiH) | 56.7 | | 59.9 | | 38.8 | 13.5 | 13.5 | — |
| [mmol/wt-%] | | | | | | | | |
| Pyrogenic | 2.6 | 3.5 | 2.6 | 3.5 | 4.0 | 2.6 | 6.4 | 5 |
| silica | | | | | | | | |
| Crystalline | 33.3 | 45.4 | 36.3 | 42.4 | 29.5 | 49.9 | 56.1 | 63.9 |
| SiO₂ | | | | | | | | |
| Silicopolyether | 3.1 | — | 3.1 | — | 1.5 | — | 0.4 | — |
| surfactant | | | | | | | | |
| Allyltrimethyl- | 3 | — | — | 3 | — | 0.8 | 1.5 | — |
| silane | | | | | | | | |
| n(Allyl) | 26.3 | — | — | 26.3 | — | 7.0 | 13.1 | — |
| [mmol/wt-%] | | | | | | | | |
| Silicone oil (10 | — | — | — | — | 7.8 | 3.8 | — | — |
| mPas) | | | | | | | | |
| Pigment | — | 0.6 | — | 0.6 | 0.5 | 0.1 | 1.0 | — |
| Tetraallylsilane | — | 0.5 | — | 0.5 | — | 0.5 | — | — |
| Pt catalyst | — | 0.4 | — | 0.4 | — | 1.6 | — | 1.0 |
| Pd dispersion | — | 0.5 | — | 0.5 | — | — | — | 0.1 |
| SiH/vinyl:molar | 8.0 | | 8.6 | | 3.5 | | 2.03 | |
| ratio | | | | | | | | |
| X/Y:molar | 2.16 | | 2.28 | | 5.54 | | 1.03 | |
| ratio of SiH | | | | | | | | |
| groups to C═C | | | | | | | | |
| groups in the | | | | | | | | |
| compound of | | | | | | | | |
| formula I | | | | | | | | |
| t⁵/min | 1.83 | | 0.96 | | 1.9 | | 1.73 | |
| (t⁹⁰ − t⁵)/min | 0.94 | | 0.72 | | 2.5 | | 1.03 | |
| ΔT/° C. | 11.7 | | 10.1 | | 5.7 | | 8.9 | |
| t^{SH} | 0:00 | | 0:00 | | 4:30 | | 01:00 | |
| PS1:PS2 | 1:2.04 | | 1:1.81 | | 1:1.16 | | — | |
| weight ratio | | | | | | | | |
| **or for | | | | | | | | |
| PS1:PS not | | | | | | | | |
| covered by the | | | | | | | | |
| invention | | | | | | | | |

*Vinyl groups were reworked with our own silicone oil content as a comparison example.

TABLE 3
Examples 1 to 4 (base paste (base), catalyst paste (catalyst)

| | Example | | Example 2 | | Example 3 | | Example 4 | |
|---|---|---|---|---|---|---|---|---|
| | Base | Catalyst | Base | Catalyst | Base | Catalyst | Base | Catalyst |
| | [wt.-%] | [wt.-%] | [wt.-%] | [wt.-%] | [wt.-%] | [wt.-%] | [wt.-%] | [wt.-%] |
| Mixture | 39 | 49.1 | 42 | 49.1 | 40.4 | 49.1 | 27.6 | 49.1 |
| PDMS Oil | | | | | | | | |
| content | | | | | | | | |
| C═C in | | | | | | | | |
| WO | | | | | | | | |
| 2013/025 | | | | | | | | |
| 494 not | | | | | | | | |
| specified * | | | | | | | | |
| Crosslinker | — | — | 2.5 | — | 5.8 | — | 12.5 | — |
| PS1 | | | | | | | | |
| (1.8 | | | | | | | | |
| mmol/g | | | | | | | | |
| SiH) | | | | | | | | |
| Crosslinker | 16 | — | 13.5 | — | 11.8 | — | 6.2 | — |
| PS2 | | | | | | | | |
| (4.17 | | | | | | | | |
| mmol/g | | | | | | | | |
| SiH) | | | | | | | | |
| n(vinyl) | 7.9 | | 7.2 | | 7.0 | | 5.7 | |
| [mmol/ | | | | | | | | |
| weight %] | | | | | | | | |
| n(SiH) | 66.7 | | 60.8 | | 59.6 | | 48.4 | |
| [mmol/ | | | | | | | | |
| wt-%] | | | | | | | | |
| Pyrogenic | 2.6 | 3.5 | 2.6 | 3.5 | 2.6 | 3.5 | 2.6 | 3.5 |
| silica | | | | | | | | |
| Crystalline | 38.5 | 45.4 | 35.5 | 45.4 | 35.5 | 45.4 | 40.0 | 45.4 |
| SiO₂ | | | | | | | | |
| Silicopoly- | 3.1 | — | 3.1 | — | 3.1 | — | 3.1 | — |
| ether- | | | | | | | | |
| surfactant | | | | | | | | |
| Allyltrimethyl- | 0.8 | — | 0.8 | — | 0.8 | — | 0.8 | — |
| silane | | | | | | | | |
| n(allyl) | 7.0 | | 7.0 | | 7.0 | | 7.0 | |
| [mmol/ | | | | | | | | |
| weight %] | | | | | | | | |
| Pigment | — | 0.6 | — | 0.6 | — | 0.6 | — | 0.6 |
| Tetraallyl- | — | 0.5 | — | 0.5 | — | 0.5 | — | 0.5 |
| silane | | | | | | | | |
| Pt catalyst | — | 0.4 | — | 0.4 | — | 0.4 | — | 0.4 |
| Pd | — | 0.5 | — | 0.5 | — | 0.5 | — | 0.5 |
| dispersion | | | | | | | | |
| SiH/ | 8.5 | | 8.5 | | 8.5 | | 8.5 | |
| vinyl:molar | | | | | | | | |
| ratio | | | | | | | | |
| X/Y:molar | 9.53 | | 8.68 | | 8.52 | | 6.91 | |
| ratio of | | | | | | | | |
| SiH | | | | | | | | |
| groups to | | | | | | | | |
| C═C | | | | | | | | |
| groups of the | | | | | | | | |
| compound of | | | | | | | | |
| formula I | | | | | | | | |
| t⁵/min | 1.46 | | 1.49 | | 1.36 | | 1.76 | |
| (t⁹⁰ − t⁵)/ | 0.61 | | 0.61 | | 0.61 | | 0.83 | |
| min | | | | | | | | |
| ΔT/° C. | 7.4 | | 7.3 | | 6.8 | | 6.1 | |
| t^{SH} | 00:00 | | 00:00 | | 00:50 | | 00:50 | |
| PS1:PS2 | 0:16 | | 1:5.4 | | 1:2.03 | | 1:0.5 | |
| weight | | | | | | | | |
| ratio | | | | | | | | |

With increasing crosslinker activity (example 1:16 wt.-% with 4.17 mmol/g Si—H vs. 6.2% 4.17 mmol/g Si—H/12.5% 1.8 mmol/g Si—H), a reduction in the time difference t₉₀−t₅ (0.61 min. (example 1) vs. 0.83 min. (example 4)) and a greater increase in Shore hardness A (see FIG. 2, 0.6 (1/min) to 1.8 (1/min) of the examples according to the invention compared to 0.18 (1/min) of comparison example 1) were observed. Compared to the prior art WO 2013/025494 A1 (content of monofunctional allyl silane relative to the total composition can—with the modification that the content of ethylene groups was selected analogously to the compositions according to the invention—be achieved with a comparatively low amount of monofunctional allyl silane (0.4 wt.-% based on total composition) and a ratio of Si—H groups (X) to allyl groups (Y) of the compound of formula I of X/Y>5 achieved already a temperature increase of about 7° C. Alternatively or additionally, the time difference t₉₀−t₅ can be reduced from 0.94 (composition with 1.5 wt.-% allyltrimethylsilane based on the total composition and a molar ratio of greater than X/Y (SiH:C═C of formula I) greater than or equal to 9.1) to 0.61.

FIG. 3 shows that, with a low molar ratio of X/Y (SiH/C═C of formula I) according to comparative example 1 (example D, U.S. Pat. No. 7,700,712 B2), allyltrimethylsilane has no influence on the increase in Shore A hardness, i.e., the setting reaction. The addition of allyltrimethylsilane only leads to a slight increase in temperature from 4.5° C. to 6.4° C.

1. Curable composition comprising addition-crosslinkable organofunctional polysiloxanes comprising
i. addition-crosslinkable polysiloxanes comprising at least two terminal ethylene groups and
ii. polysiloxanes comprising at least two Si—H groups, wherein the polysiloxanes comprising Si—H groups have a content of polysiloxanes with a content of Si—H groups of 4.1 mmol/g to 15 mmol/g, and optionally comprising a hydrosilylation catalyst,
wherein
it comprises 3 to 25 wt.-% of polysiloxanes containing Si—H groups with a Si—H group content of 4.1 to 15 mmol/g,
based on the total composition of 100 wt.-% of the curable composition.

2. Composition according to claim 1, wherein the curable composition comprises a monounsaturated compound of formula I 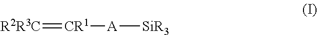
with
R each independently selected from H, monovalent alkyl group with 1 to 22 C atoms, aryl group with 16 to 12 C atoms, O—SiR⁴₃ group, wherein R optionally comprises hetero atoms, with the provision that R is not an alkoxy group or arylalkoxy group,
R¹, R², R³ are each independently selected from H, monovalent alkyl group with 1 to 22 C atoms, aryl groups with 6 to 12 C atoms and optionally independently comprise heteroatoms,
R⁴ is a monovalent alkyl group with 1 to 22 carbon atoms or an aryl group with 6 to 12 carbon atoms, wherein optionally two or three R⁴ radicals form a cyclic or polycyclic structure in O—SiR⁴₃,
A is a bivalent linear, branched or cyclic hydrocarbon group with 1 to 12 C atoms, optionally comprising an aromatic compound with at least one methylene group which is directly covalently bonded to the aromatic compound, optionally comprising —O atoms, preferably A is methylene, ethylene, propylene, butylene, hexylene, octylene, nonylene or decylene,
wherein the molar ratio of Si—H groups, the polysiloxanes comprising Si—H groups, to the monounsaturated compound of formula I is greater than 6.

3. Composition according to claim 1, wherein the molar ratio of Si—H groups of the polysiloxanes, of the polysiloxanes comprising at least two Si—H groups with a content of Si—H groups of 4.1 mmol/g to 15 mmol/g, to ethylene groups of the polysiloxanes is from 4:1 to 10:1.

4. Composition according to claim 1, wherein the curable composition does not contain any monounsaturated compound of formula I or the content of the monounsaturated compound of formula I in the curable composition is from 0.001 to 0.5 wt.-%,
wherein the total content of the composition being 100 wt.-%.

5. Composition according to claim 1, wherein the
ii. polysiloxanes comprising at least two Si—H groups comprise at least two polysiloxane compositions with different Si—H group contents, wherein a first polysiloxane composition (PS1) having a Si—H group content of 1 to 3.5 mmol/g and a second polysiloxane composition (PS2) having a Si—H group content of 4.1 mmol/g to 15 mmol/g, wherein the first polysiloxane composition (PS1) with a Si—H group content and the second polysiloxane composition (PS2) having a Si—H group content in a weight ratio of 1:1.5 to 1:10, and
wherein the molar ratio of Si—H groups of the polysiloxanes to ethylene groups of the polysiloxanes is from 4:1 to 10:1, and
comprising a hydrosilylation catalyst.

6. Composition according to claim 1, wherein the polysiloxanes comprising Si—H groups having a Si—H group content of 4.1 to 15 mmol/g (second polysiloxane composition PS2) in a weight ratio greater than 2, with respect to the polysiloxanes comprising Si—H groups with a Si—H group content of less than 4.0 mmol/g Si—H groups, in particular with respect to polysiloxanes with a Si—H group content of 1 to 3.55 mmol/g (first polysiloxane composition PS1).

7. Composition according to claim 2, wherein the molar ratio of
Si—H groups of the polydisiloxanes to ethylene groups of the compound of formula I is greater than 5.

8. Composition according to claim 2, wherein the molar ratio of Si—H groups of the polydisiloxanes to ethylene groups of the compound of formula I with greater than or equal to 4.1 mmol/g is greater than 5.

9. Composition according to claim 1, wherein the addition-crosslinking polysiloxanes comprising at least two terminal ethylene groups comprise polydialkylsiloxanes, polydialkylsiloxane ethers or mixtures thereof, with alkyls each independently having 1 to 16 carbon atoms.

10. Composition according to claim 2, wherein the curable composition contains 0.1 to 0.5 wt.-% of at least one monounsaturated compound of
formula I, wherein the total content of the composition is 100 wt.-%.

11. The composition according to claim 1, wherein the
(i) maximum temperature increase (ΔT) during curing is less than or equal to 7° C., wherein the temperature increase is measured with a temperature sensor in the mass in the time interval 15 seconds from the first mixing until 10 minutes after the first mixing, in particular with a temperature measurement every 30 seconds, and/or
(ii) the value t₅ in minutes from the first mixing of the complex viscosity (DIN53505) corresponds to 5% and t₉₀ in minutes of the complex viscosity of 90% of the complex viscosity 10 minutes after the start of mixing, wherein t₉₀ is less than or equal to 1.7 minutes, and/or
(iii) the value t₉₀−t₅ as the difference between t₉₀ of the complex viscosity with 90% of the complex viscosity and the time of t₅ of the complex viscosity with 5% of the complex viscosity 10 minutes after the start of mixing is less than or equal to 0.9 minutes.

12. Composition according to claim 1, wherein the composition comprises a content of tetraallylsilane.

13. Composition according to claim 1, wherein it comprises at least one surfactant comprising a polyether, polyether-functionalized siloxane oligomer, fatty alcohol and/or fluorosurfactant or mixtures of the aforementioned surfactants.

14. Composition according to claim 1, wherein the addition-crosslinking polysiloxanes comprising at least two terminal ethylene groups have a content of ethylene groups of 0.01 mmol/g to 10 mmol/g ethylene groups.

15. Composition according to claim 1, wherein the molar ratio of Si—H groups of the polysiloxanes to ethylene groups of the polysiloxanes is from 3.5:1 to 10:1.

16. Composition according to claim 1, wherein the curable composition is obtainable by mixing two components to obtain an addition-crosslinkable curable composition,
wherein the two components comprise:
i) base component comprising addition-crosslinkable polysiloxanes comprising at least two terminal ethylene groups and polydialkylsiloxanes comprising Si—H groups, and
ii) catalyst component comprising a platinum, rhodium and/or palladium hydrosilylation catalyst and optionally comprising addition-crosslinking polysiloxanes comprising of at least two terminal ethylene groups and optionally polysiloxanes comprising at least two Si—H groups of
and optionally
wherein the base component and/or the catalyst component each independently comprising
optionally inorganic fillers, organic particulate polymers,
and
optionally pigments comprising organic or inorganic pigments.

17. Composition according to claim 1, wherein
the composition is obtainable by mixing a
i) base component and
ii) catalyst component, wherein
i) the base component comprises
30 to 50 wt.-% of polydialkylsiloxanes comprising at least two terminal ethylene groups,
15 to 64 wt.-% inorganic fillers,
5 to 30 wt.-% of polydialkylsiloxanes comprising at least two Si—H groups,
1.0 to 15 wt.-% of at least one surfactant, and
wherein the total amount of the base component is 100 wt.-%, and
ii) the catalyst component comprises
20 to 80 wt.-% of polydialkylsiloxanes comprising at least two terminal ethylene groups,
5 to 70 wt.-% inorganic fillers,
0.001 to 5.0 wt.-% of a hydrosilylation catalyst comprising platinum, rhodium or palladium,
0 to 15 wt.-% of at least one surfactant, and
0 to 10 wt.-% organic or inorganic pigments and/or structuring agents,
wherein the total amount of catalyst components is 100 wt.-%.

18. Composition according to claim 1, wherein
the composition is obtainable by mixing a
i) base component and
ii) catalyst component, wherein
i) the base component comprises
30 to 50 wt.-% of polydialkylsiloxanes comprising at least two terminal ethylene groups,
ii) the catalyst component comprises
20 to 80 wt.-% of polydialkylsiloxanes comprising at least two terminal ethylene groups, and wherein the ratio of terminal ethylene groups of the base component to terminal ethylene groups of the catalyst component is in a molar ratio of 1:1.1 to 1:10.

19. Kit comprising a 2K dispensing device comprising at least two cartridges, wherein one cartridge comprises i) the base component according to claim 16 and the second cartridge comprises ii) the catalyst components according to claim 16.

20. Method of use of a composition according to claim 1 or a kit according to claim 19, wherein the composition is obtainable by mixing a i) base component and ii) catalyst component, for making impressions in the medical field, dental field, and/or veterinary field, for making impressions in the field of botany, for making impressions in the marine and aquatic field, for making impressions of surfaces of articles, for making impressions of designs, art or handicraft objects, as a dental impression material, as an impression material for human, veterinary or marine soft (tissue) and/or hard structures (bones, shells, coral), oral impressions, podiatry, for making impressions of electronic components, for making impressions of objects whose surfaces are wetted with aqueous compositions or whose surfaces are wetted with water, and/or for printing three-dimensional structures, particularly in the semiconductor field.

21. Composition according to claim 6, wherein the polysiloxanes comprising Si—H groups having a Si—H group content of 4.1 to 15 mmol/g (second polysiloxane composition PS2) in a weight ratio greater than or equal to 5, with respect to the polysiloxanes comprising Si—H groups with a Si—H group content of less than 4.0 mmol/g Si—H groups, in particular with respect to polysiloxanes with a Si—H group content of 1 to 3.55 mmol/g (first polysiloxane composition PS1).

22. Composition according to claim 7, wherein the molar ratio of Si—H groups of the polydisiloxanes to ethylene groups of the compound of formula I is greater than 6.5.

23. Composition according to claim 9, wherein the addition-crosslinking polysiloxanes comprising at least two terminal ethylene groups comprising polydimethylsiloxanes, polydimethylsiloxane ethers or mixtures thereof.

24. Composition according to claim 16, wherein the curable composition is obtainable by mixing two components to obtain an addition-crosslinkable curable composition, wherein the two components comprise:
i) base component comprising addition-crosslinkable polydialkylsiloxanes comprising at least two terminal vinyl-groups and polydialkylsiloxanes comprising at least two Si—H groups, and
ii) catalyst component comprising a platinum, rhodium and/or palladium hydrosilylation catalyst and optionally comprising addition-crosslinking polydialkylsiloxanes comprising of at least two terminal vinyl-groups and optionally polydialkylsiloxanes comprising at least two Si—H groups
and
wherein the base component and/or the catalyst component each independently comprising
inorganic fillers and/or organic particulate polymers.

25. Composition according to claim 18, wherein the molar ratio is 1:1.4 to 1:2
